(19) United States
(12) Patent Application Publication
(10) Pub. No.: US 2003/0012353 A1
(43) Pub. Date: Jan. 16, 2003

(54) Photo caller ID

(76) Inventors: Ji Tang, Milpitas, CA (US); Takahiro Fujimori, San Jose, CA (US)

Correspondence Address: MILLER PATENT SERVICES, 2500 DOCKERY LANE, RALEIGH, NC, 27606, US

(21) Appl. No.: 09/901,348

(22) Filed: Jul. 9, 2001

(51) Int. Cl. H04M 1/56

(52) U.S. Cl. 379/142.17

(57) ABSTRACT

A system and method for providing a photo enhanced caller ID service. A photo image is associated with a subscriber telephone line and stored at a local office or central office. When the subscriber places a telephone call, caller ID information along with the photographic image is transmitted to the called party. At the called party premises, the photo image is displayed either on a telephone set equipped with a suitable display or on a television set via a TV set-top box or other similar hardware to permit display of the telephone called on a monitor.

### FIELD OF THE INVENTION

This invention relates generally to the field of telephone communication. More particularly, this invention relates to a photographic caller ID system and method.

### BACKGROUND OF THE INVENTION

Recently, caller ID has become a popular option for telephone subscribers. In a system providing caller ID service, when a calling party makes a telephone call to a called party, the calling party's telephone number and other identifying information such as name is sent to the called party's telephone line when the connection is made. By use of special equipment at the called party's side, the called party may view a display to see the telephone number and identifying information of the party placing the telephone call. In such a system, the called party normally subscribes to the service in order to learn the identity of the calling party so that call screening may be effected or so that the called party has advance warning of who is calling. The present invention seeks to enhance this service to provide the subscriber with greater functionality in an enhanced photo caller ID system.

### SUMMARY OF THE INVENTION

The present invention relates generally to a photo caller ID. Objects, advantages and features of the invention will become apparent to those skilled in the art upon consideration of the following detailed description of the invention.

In one embodiment of the present invention, a system and method for providing a photo enhanced caller ID service is provided in which a photographic image file is associated with a subscriber telephone line and stored at a local office or central office. When the subscriber places a telephone call, caller ID information along with the photographic image is transmitted to the called party. At the called party premises, the photo image is displayed either on a telephone set equipped with a suitable display or on a television set via a TV set-top box or other similar hardware to permit display of the telephone called on a monitor.

A method of providing a photo caller identification function consistent with an embodiment of the present includes detecting that a calling telephone line has gone off hook; mapping the calling telephone line to an image file containing an image; determining a destination for a telephone call; and sending the image file to the destination.

A method of providing a photo caller identification function consistent with an embodiment of the present invention includes receiving an indication of an incoming voice telephone call; receiving an image file containing an image associated with a calling party; and displaying the image file.

A method of providing a photo caller identification function consistent with another embodiment of the present invention includes receiving an indication of an incoming voice telephone call; receiving an image file containing an image associated with a calling party; in a television Set-Top Box, converting the image file to a form suitable for display on a display; and displaying the image file on the display, the display forming a part of a television set.

A television Set-Top Box providing a photo caller identification function consistent with an embodiment of the present invention includes a telephone interface that receives an indication of an incoming voice telephone call and an image file containing an image associated with a calling party. A processor converts the image file to a form suitable for display on a display. A display interface sends the image file to the display, the display forming a part of a television set.

A telephone that provides a photo caller identification function consistent with an embodiment of the present invention includes a telephone interface that receives an indication of an incoming voice telephone call and an image file containing an image associated with a calling party; a display; a processor that converts the image file to a form suitable for display on the display; and a display interface that sends the image file to the display.

Any of the above methods can be implemented in a programmed processor using instructions stored in any suitable electronic storage medium.

The above summaries are intended to illustrate exemplary embodiments of the invention, which will be best understood in conjunction with the detailed description to follow, and are not intended to limit the scope of the appended claims.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is a block diagram illustration a system consistent with an embodiment of the present invention.

FIG. 2 illustrates a telephone handset utilized in an embodiment consistent with the present invention.

FIG. 3 is a flow chart depicting an embodiment of a process consistent with the present invention.

### DETAILED DESCRIPTION OF THE INVENTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawings.

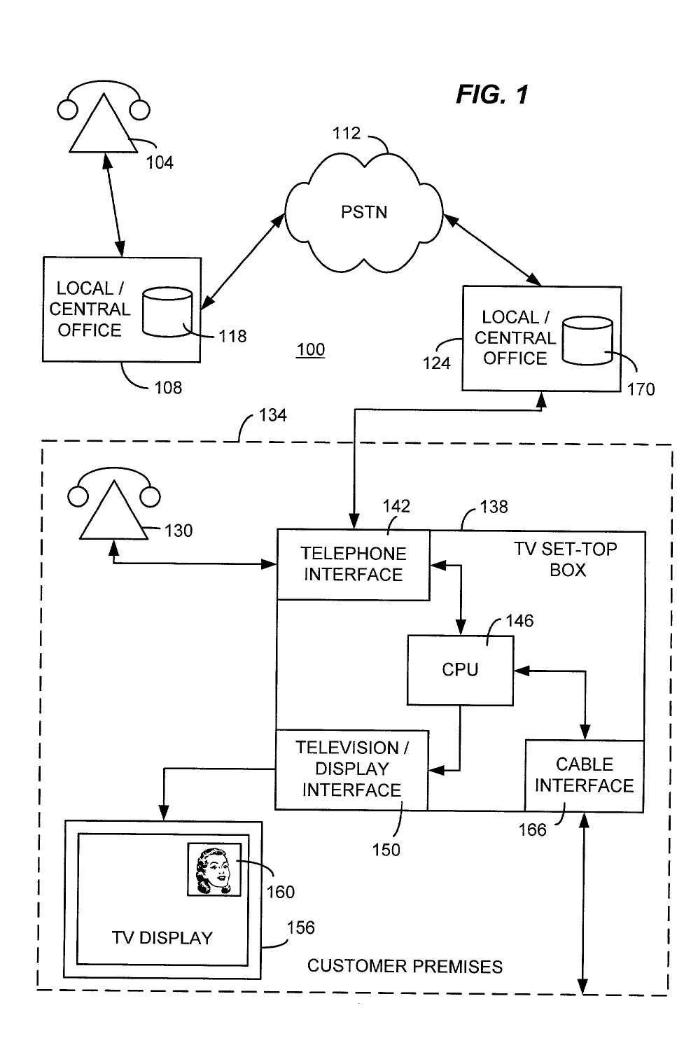

In accordance with an embodiment of the present invention, a caller ID system is provided in which a calling party's photograph, graphic or logo is transmitted as an electronic file to a subscriber for viewing upon initiation of a phone call. FIG. 1 illustrates an exemplary system 100 for effecting the photo caller ID system consistent with one embodiment of the present invention. System 100 includes an exemplary telephone set 104 connected through a local office (or equivalently a central office) 108 forming a part of the public switched telephone network (PSTN) 112. The local office 108 (or equivalently central office) includes a database 118 that stores caller ID information associated with each line connected to the central office from a customer.

In general, when a telephone call is to be completed from the telephone set 104, the telephone set 104 is connected through the local office or central office 108 through the PSTN 112 and through another (or the same) central or local office 124 to the customer premises 134 of the called party in order to effect a connection between telephone set 104 and telephone set 130. In accordance with an embodiment of the present invention, when the user of telephone set 104 places a call, the caller ID database 118 retrieves not only conventional caller ID information (a telephone number and a name) but also a computer file containing a preferably compressed image associated with telephone set 104. This caller ID information including the computer image file is then sent to the called party. In accordance with the preferred embodiment, the image may be a compressed file of a user (or users) of telephone set 104. In other embodiments, for example in a company telephone, the file may contain a company logo rather than a photographic type image.

In accordance with the present embodiment, telephone set 130 is situated at a customer premises site 134 which may be a residential site. Telephone set 130 is connected to a television Set-Top Box (STB) 138 which is in turn connected to the telephone circuit leading ultimately to the local office 124. Telephone circuit 142 of TV Set-Top Box 138 passes the caller ID information to a central processor (CPU) 146 that interprets the caller ID information and passes it on to a television/display interface 150 for display on a television monitor or display 156. In the preferred embodiment, the image is displayed as a window 160 appearing in the normal television display and overlaying any currently displayed programming. Window 160 may show an image, a logo, a graphic as well as possibly the conventional caller ID information (not shown.) Set-Top Box 138 also may include cable or satellite interface such as 166 that connects to a broadband communication system for receipt of conventional television programming. In the case of customer premise telephone set 130 originating the telephone call, a similar database 170 resides at the local office or central office 124 containing identifying information associated with the customer premise 134.

Thus, when the user of telephone 104 places a telephone call to telephone set 130, the local office 108 retrieves conventional caller ID information from database 118 and passes it through the public switch telephone network 112 until it ultimately reaches Set-Top Box 138. As telephone set 130 is ringing, TV Set-Top Box 138 reads the incoming photo caller ID data, converts it to a form that can be displayed on a TV display such as 156 and proceeds to display the information as a window overlaying the current programming in window 160. In this manner, the user at customer premises 134 cannot only obtain the benefit of conventional caller ID information, but can instantly recognize the calling party by virtue of their image appearing on the television display 156.

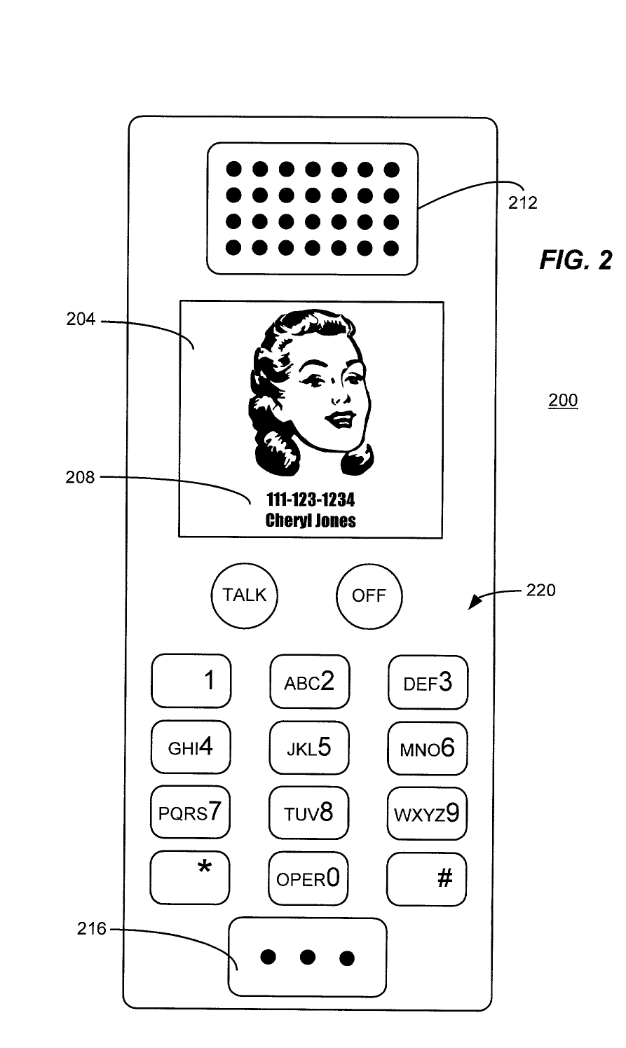

Referring now to FIG. 2, the present invention may also be embodied in a telephone hand set 200 having a display 204, preferably color, with high enough resolution to present a readily discernable image of the calling party as well as, possibly, conventional caller ID information illustrated as 208. Telephone set 200, in addition to display 204, has other conventional telephone components including an earpiece 212, a mouthpiece 216 and a keyboard region shown generally as 220. The telephone set 200 operates in a manner similar to that of the Set-Top Box 138 in that it has a central processing unit (CPU) that receives the photo caller ID information from the telephone interface and formats the information in a manner suitable for display on the display 204 (which is probably a limited resolution display compared with display 156.)

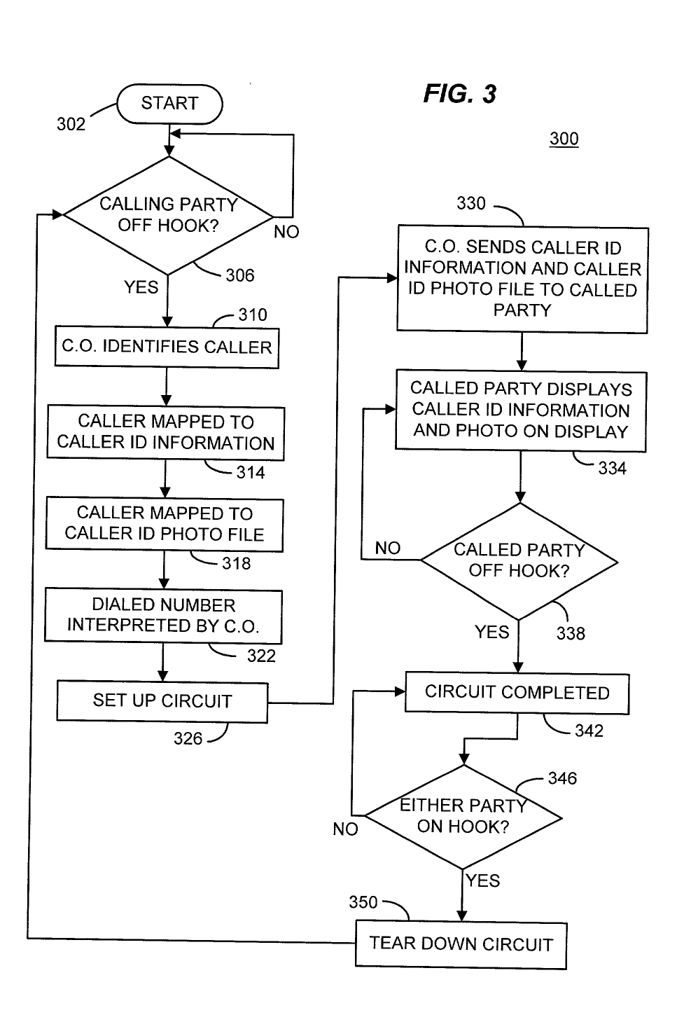

Referring now to FIG. 3, a process for implementing an exemplary photo caller ID system in accordance with the present invention is illustrated starting at 302. At 306 when a calling party goes off hook, the central office or local office identifies the caller at 310 and the caller's telephone number (identity) is mapped to caller ID information at 314. TABLE 1 illustrates an exemplary mapping table that indexes caller ID name and a photo image file for several users by telephone number. In the case of a caller that does not submit a photo caller ID image file, the entry is left blank. As shown in TABLE 1, conventional images may be stored using a file name containing the telephone number or may be any other file name with a compatible file format. In the case of a corporation, a logo file may be substituted for a photographic image.

TABLE 1

| TELEPHONE | | PHOTO CALLER ID |
|---|---|---|
| NUMBER | CALLER ID NAME | IMAGE |
| . . . | | |
| 111-222-0001 | GEORGE W. SMITH | 1112220001.JPG |
| 111-222-0002 | HAZEL J. BARKER | 1112220002.JPG |
| 111-222-0003 | XYZ CORPORATION, INC. | XYZ_INC_LOGO.GIF |
| 111-222-0004 | SAMUEL MILLER | |
| 111-222-0005 | ABLE CONSULTING, INC. | 1112220005.JPG |
| . . . | | |

The caller ID photo file is best mapped along with other caller ID information at 302. At 322, the dialed number is interpreted by the central office or local office and a circuit is set up at 326. The central office or local office then sends the caller ID information and caller ID photo file to the called party at 330. At 334 the called party displays the caller information and the photo on his or her available display, be it part of a telephone or part of another display system such as the Set-Top Box and television embodiment. This is displayed until shortly after the called party goes off hook and answers the telephone at 338 in the preferred embodiment (but may stay on the display for as long as desired by those implementing the system). Once the called party goes off hook at 338, the circuit is completed at 342 until such time as either party goes on hook at 346 by hanging up their telephone set. Once one of the parties hangs up their telephone set at 346 the circuit is torn down at 350 and control returns to 306.

Thus, a method and apparatus has been illustrated for providing a caller ID system with photo capabilities. Those skilled in the art will appreciate many variations are possible in this system including restrictions on file types, file sizes, location of the database, and other implementation details and variations.

Those skilled in the art will recognize that the present invention has been described in terms of exemplary embodiments based upon use of a programmed processor. However, the invention should not be so limited, since the present invention could be implemented using hardware component equivalents such as special purpose hardware and/or dedicated processors which are equivalents to the invention as described and claimed. Similarly, general purpose computers, microprocessor based computers, micro-controllers, optical computers, analog computers, dedicated processors and/or dedicated hard wired logic may be used to construct alternative equivalent embodiments of the present invention.

Those skilled in the art will appreciate that the program steps and associated data used to implement the embodiments described above can be implemented using disc storage as well as other forms of storage including Read Only Memory (ROM) devices, Random Access Memory (RAM) devices; optical storage elements, magnetic storage elements, magneto-optical storage elements, flash memory, core memory and/or other equivalent storage technologies without departing from the present invention. Such alternative storage devices should be considered equivalents.

The present invention is preferably implemented using a programmed processor executing programming instructions that are broadly described above in flow chart form that can be stored on any suitable electronic storage medium or transmitted over any suitable electronic communication medium. However, those skilled in the art will appreciate that the processes described above can be implemented in any number of variations and in many suitable programming languages without departing from the present invention. For example, the order of certain operations carried out can often be varied, and additional operations can be added without departing from the invention. Error trapping can be added and/or enhanced and variations can be made in user interface and information presentation without departing from the present invention. Such variations are contemplated and considered equivalent.

While the invention has been described in conjunction with specific embodiments, it is evident that many alternatives, modifications, permutations and variations will become apparent to those skilled in the art in light of the foregoing description. Accordingly, it is intended that the present invention embrace all such alternatives, modifications and variations as fall within the scope of the appended claims.

What is claimed is:

1. A method of providing a photo caller identification function, comprising:
detecting that a calling telephone line has gone off hook;
mapping the calling telephone line to an image file containing an image;
determining a destination for a telephone call; and
sending the image file to the destination.

2. The method according to claim 1, wherein the image file is stored in a database at a telephone office.

3. The method according to claim 1, wherein the image file contains a photographic image associated with a calling party.

4. The method according to claim 1, wherein the image file contains a graphic image associated with a calling party.

5. The method according to claim 4, wherein the graphic image represents a company logo.

6. The method according to claim 1, further comprising sending caller ID information to the destination.

7. A method of providing a photo caller identification function, comprising:
receiving an indication of an incoming voice telephone call;
receiving an image file containing an image associated with a calling party; and
displaying the image file.

8. The method according to claim 7, wherein the image file is stored in a database at a telephone office.

9. The method according to claim 7, wherein the image file contains a photographic image associated with a calling party.

10. The method according to claim 7, wherein the image file contains a graphic image associated with a calling party.

11. The method according to claim 10, wherein the graphic image represents a company logo.

12. The method according to claim 7, wherein the image is displayed on a display forming a part of a telephone set.

13. The method according to claim 7, wherein the image is displayed on a display forming a part of a television set.

14. The method according to claim 7, further comprising converting the image file to a form suitable for display on the display.

15. The method according to claim 14, wherein the converting is carried out in a television Set-Top Box.

16. The method according to claim 14, wherein the image file is displayed as a window that overlays a currently displayed image.

17. The method according to claim 7, further comprising receiving caller ID information, displaying the caller ID information on the display.

18. A method of providing a photo caller identification function, comprising:
receiving an indication of an incoming voice telephone call;
receiving an image file containing an image associated with a calling party;
in a television Set-Top Box, converting the image file to a form suitable for display on a display; and
displaying the image file on the display, the display forming a part of a television set.

19. The method according to claim 18, wherein the image file is stored in a database at a telephone office.

20. The method according to claim 18, wherein the image file contains a photographic image associated with a calling party.

21. The method according to claim 18, wherein the image file contains a graphic image associated with a calling party.

22. The method according to claim 18, wherein the graphic image represents a company logo.

23. The method according to claim 18, wherein the image file is displayed as a window that overlays a currently displayed image.

24. The method according to claim 27, receiving caller ID information, converting the caller ID information into a form suitable for display on the display, and displaying the caller ID information on the display.

25. A television Set-Top Box providing a photo caller identification function, comprising:
a telephone interface that receives an indication of an incoming voice telephone call and an image file containing an image associated with a calling party;
a processor that converts the image file to a form suitable for display on a display; and
a display interface that sends the image file to the display, the display forming a part of a television set.

26. The apparatus according to claim 25, wherein the image file contains a photographic image associated with a calling party.

27. The apparatus according to claim 25, wherein the image file contains a graphic image associated with a calling party.

28. The apparatus according to claim 25, wherein the graphic image represents a company logo.

29. The apparatus according to claim 25, wherein the display interface sends the image file to the display as a window that overlays a currently displayed image.

30. The apparatus according to claim 25, wherein the telephone interface further receives caller ID information, and wherein the processor converts the caller ID information into a form suitable for display on the display and wherein the display interface sends the caller ID information to the display.

31. A telephone that provides a photo caller identification function, comprising:
a telephone interface that receives an indication of an incoming voice telephone call and an image file containing an image associated with a calling party;
a display;
a processor that converts the image file to a form suitable for display on the display; and
a display interface that sends the image file to the display.

32. The apparatus according to claim 31, wherein the image file contains a photographic image associated with a calling party.

33. The apparatus according to claim 31, wherein the image file contains a graphic image associated with a calling party.

34. The apparatus according to claim 31, wherein the graphic image represents a company logo.

35. The apparatus according to claim 31, wherein the display interface sends the image file to the display as a window that overlays a currently displayed image.

36. The apparatus according to claim 31, wherein the telephone interface further receives caller ID information, and wherein the processor converts the caller ID information into a form suitable for display on the display and wherein the display interface sends the caller ID information to the display.

37. An electronic storage medium storing instructions which, when executed on a programmed processor, carry out a method of providing a photo caller identification function, comprising:
detecting that a calling telephone line has gone off hook;
mapping the calling telephone line to an image file containing an image;
detecting a destination for a telephone call; and
sending the image file to the destination.

38. An electronic storage medium storing instructions which, when executed on a programmed processor, carry out a method of providing a photo caller identification function, comprising:
receiving an indication of an incoming voice telephone call;
receiving an image file containing an image associated with a calling party; and
displaying the image file.

39. An electronic storage medium storing instructions which, when executed on a programmed processor, carry out a method of providing a photo caller identification function, comprising:
receiving an indication of an incoming voice telephone call;
receiving an image file containing an image associated with a calling party;
in a television Set-Top Box, converting the image file to a form suitable for display on a display; and
displaying the image file on the display, the display forming a part of a television set.
